(19) United States
(12) Patent Application Publication
(10) Pub. No.: US 2008/0280254 A1
(43) Pub. Date: Nov. 13, 2008

(54) Molar Implant and Method

(75) Inventor: Andrew Ackermann, Sandton (ZA)

Correspondence Address: ROTHWELL, FIGG, ERNST & MANBECK, P.C., 1425 K STREET, N.W., SUITE 800, WASHINGTON, DC, 20005, US

(73) Assignee: SOUTHERN IMPLANTS (PTY) LTD., Centurion (ZA)

(21) Appl. No.: 11/721,279

(22) PCT Filed: May 26, 2006
(86) PCT No.: PCT/IB2006/001373

§ 371 Date: Jul. 18, 2008

(30) Foreign Application Priority Data
Nov. 3, 2005 (ZA) 2005/08926

(51) Int. Cl. A61C 8/00

(52) U.S. Cl. 433/174

(57) ABSTRACT

One aspect of the invention concerns a molar implant (24). The implant has a body with a coronal end (26) into which a threaded bore (60) extends to receive a fastener for a prosthesis. There is an externally threaded shank (34) extending apically from the outer end, at least a portion of the shank being inwardly tapered. The coronal end has a diameter of at least 7 mm and the shank has a taper angle in the range 10° to 25°. Another aspect of the invention concerns a surgical method in which a molar tooth (12) is extracted from a maxilla or mandible and a hole (22) is formed in the bone (10) of the maxilla or mandible at a generally central position relative to the sockets (16) left by the extracted molar tooth. This hole typically has a diameter greater than the lateral dimensions of the sockets. It is then possible to screw into the hole an implant (24) as described above.

### CROSS-REFERENCE TO RELATED APPLICATION

This application is a National Phase of International Application Serial No. PCT/IB06/01373, filed 26 May 2006.

### BACKGROUND TO THE INVENTION

THIS invention relates to a molar implant, i.e. a dental implant designed for use in molar implantation, and to a surgical method.

Commonly used dental implant assemblies include an implant which is implanted in a patient's jawbone and a prosthesis, typically in the form of a prosthetic tooth or abutment, which is subsequently anchored to the implant. The implant typically has a tapered, threaded shank which is screwed into a hole in the jawbone.

Molar teeth usually have multiple roots, often three in the case of maxillary molar teeth and two in the case of mandibular molar teeth. When a molar tooth is extracted the roots leave multiple root sockets with relatively small lateral dimensions in the jawbone. In common implantation practice, the shank of the implant is screwed into a selected one of these sockets. For this reason, the threaded shanks of existing implants are relatively slender to enable them to engage the socket securely when screwed home. However a problem with this conventional practice is that the root sockets are not centrally disposed with respect to the tooth itself. This means that the implant is not centralised after conventional implantation in a multi-root socket and this can result in difficulties achieving proper location, orientation and centralisation of the implant and subsequently the prosthesis.

The present invention seeks to address this problem.

### SUMMARY OF THE INVENTION

According to one aspect of the present invention there is provided a molar implant comprising a body having a coronal end into which a threaded bore extends to receive a fastener for a prosthesis and an externally threaded shank extending from the coronal end, at least a portion of the shank being inwardly tapered, the coronal end having a diameter of at least 7 mm and the shank having a taper angle in the range 10° to 25°.

Preferably the taper angle of the shank is in the range 11.6° to 19.9°.

In preferred embodiments, the shank has a round cylindrical, threaded portion adjacent the coronal end and a conically tapered portion extending apically from the round cylindrical portion. In such embodiments, the thread of the round cylindrical portion of the shank may define a greater major diameter than the coronal end. The thread of the round cylindrical portion of the shank in such cases may define a major diameter exceeding 8 mm. In alternative arrangements, the diameter of the coronal end may be greater than the major diameter of the cylindrical portion of the shank, or the diameters may be the same.

In some cases, the coronal end, the threaded bore and the shank are coaxially aligned with one another. In other cases, the coronal end and the threaded bore have a common, first axis and the shank has a second axis which is inclined relative to the first axis.

The coronal end may carry a tool-engagable boss. There may also be plurality of blind holes in a coronal surface. Alternatively, the coronal end may have a tool-engagable socket therein leading to the threaded bore.

In preferred embodiments, there may be at least one external, longitudinally extending groove or flute intersecting the thread of the shank. Advantageously, the respective ends of each groove terminate short of the ends of the thread.

Another aspect of the invention provides a surgical method including the steps of extracting a molar tooth from a maxilla or mandible, forming a hole in the bone of the maxilla or mandible at a generally central position relative to the sockets left by the extracted molar tooth, and screwing an implant into the formed hole, the implant comprising a body having a coronal end into which a threaded bore extends to receive a fastener for a prosthesis and an externally threaded shank extending apically from the coronal end, at least a portion of the shank being inwardly tapered, the coronal end having a diameter of at least 7 mm and the shank having a taper angle in the range 10° to 25°.

### BRIEF DESCRIPTION OF THE DRAWINGS

The invention will now be described in more detail, by way of example only, with reference to the accompanying drawings in which:

FIG. 1 illustrates, in diagrammatic cross-section, a portion of a maxilla and the anchorage of a molar tooth therein;

FIG. 2 diagrammatically illustrates sockets left in the maxilla after removal of the molar tooth;

FIG. 3 shows a cross-sectional side view of a molar implant according to a first embodiment of the invention;

FIG. 4 shows an end view, on the arrow 4 in FIG. 3, of the molar implant;

FIG. 5 shows a cross-sectional side view of a molar implant according to a second embodiment of the invention;

FIG. 6 shows a cross-sectional side view of a molar implant according to a third embodiment of the invention;

FIG. 7 shows a cross-sectional side view of a molar implant according to a fourth embodiment of the invention;

FIG. 8 shows a side view of a modified implant; and

FIG. 9 shows a cross-section at the line 9-9 in FIG. 8.

### DESCRIPTION OF THE ILLUSTRATED EMBODIMENTS

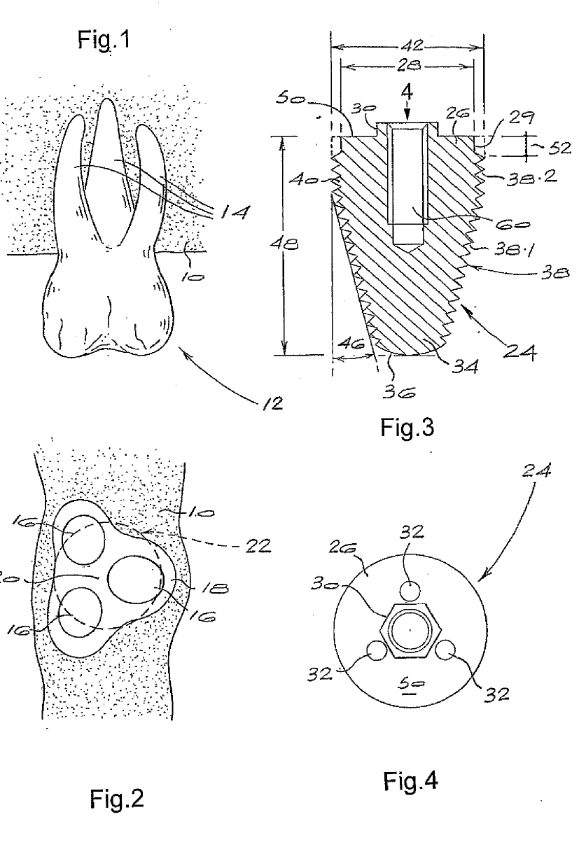

In FIGS. 1 and 2 a maxillary bone is indicated by the numeral 10. In FIG. 1, the numeral 12 indicates a molar tooth having three roots 14. Extraction of the tooth from the bone 10 leaves three corresponding root sockets 16, as shown in FIG. 2, with surrounding bone structure 18 having a central region 20 between the respective sockets.

As indicated previously conventional practice might be to anchor a molar implant in a selected one of the sockets 16. This can result in non-central placement of the implant, leading possibly to biomechanical and physiological problems in the final implant assembly. Also, in order to achieve primary stability in the anchorage of the implant to the bone, it is required that the implant have a threaded shank which is relatively slender to enable it to be screwed into the selected socket.

The present invention proposes a different implantation technique in which a hole indicated by the line 22 is drilled, reamed or otherwise formed centrally in the bone and the implant which is anchored therein is of greater diameter than those used conventionally.

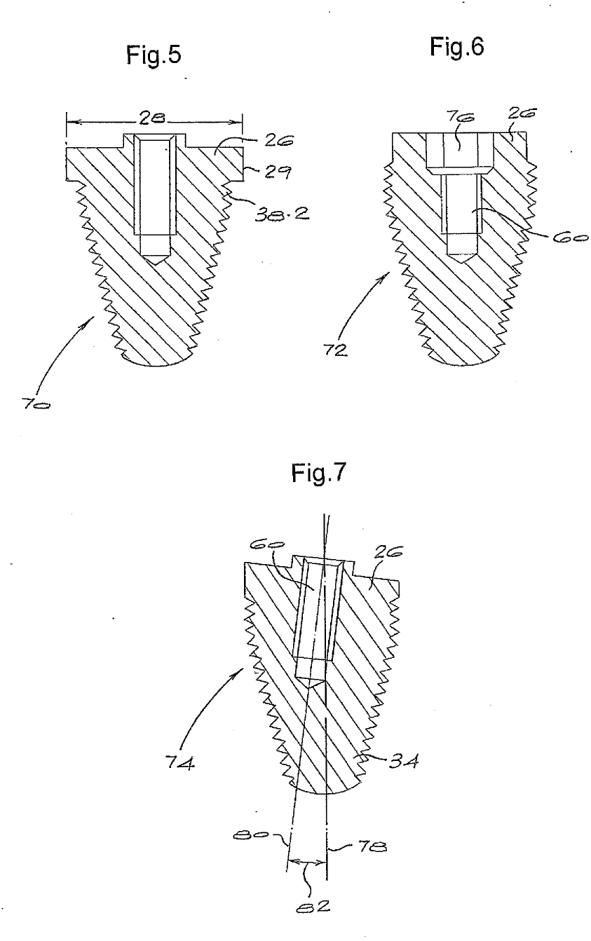

A suitable implant 24 is illustrated in FIGS. 3 and 4. The implant 24 has an operatively outer or coronal end 26 of circular cross-section and having a diameter 28 of 7 mm. In other embodiments the diameter 28 may exceed 7 mm. The coronal end 26 is formed with a central, projecting boss 30 of hexagonal cross-section and with three small, blind holes 32 equiangularly spaced apart around the boss.

The implant also has a conically tapered, threaded shank 34 extending inwardly, i.e. apically, from the coronal end 26 to a rounded, inner or apical end 36. The external thread 38 of the shank has a tapered portion 38.1 at the apical end and a cylindrical portion 38.2 at the coronal end. It will be noted that the latter portion of the thread 38 stands laterally proud of the circumferential surface 29 of the coronal end 26, such that the major diameter 42 of the thread, defined by the crests of the threads in the portion 38.2, is greater than the diameter 28 of the coronal end. In this case, the major diameter 42 is 8 mm but in other embodiments, the diameter 42 may exceed 8 mm.

The taper angle of the shank is indicated by the numeral 46. This angle, and the overall length 48 of the implant, measured from the end surface 50 to the end 36, are selected in dependence on the intended location of the implant and the geometry and dimensions of the jawbone at that specific location. For instance, in a situation where it is not possible to form a deep hole 22 because the bone geometry and dimensions are such that there would then be an insufficient thickness of bone at the end of the hole, the preference would be for a shorter implant, i.e. an implant having a shorter shank and in which the shank has a greater taper angle 46. In other situations where the bone structure is capable of accommodating a deeper hole 22, the preference would be for a longer implant with a smaller taper angle.

Implants according to the invention, and having a major diameter 42 of 8 mm as described above, will typically have an overall length 48 varying between 7 mm and 15 mm with corresponding taper angles 46 varying between 25° and 10°, typically between 19.9° and 11.6°. In FIG. 3, the dimension 52, being the distance between the end surface 50 and the commencement of the thread 38, is of the order of 0.7 mm.

The same distance will apply in other cases, so the overall threaded length will typically vary between about 6.3 mm and 14.3 mm.

Persons skilled in the art will recognise firstly that the diameter of the implant and the taper angles are somewhat greater than those conventionally used. The fact that implants of the invention have a greater diameter than previously used implants means that they are suitable for anchorage in the centrally formed hole 22 which is of larger diameter than the lateral dimension of the root sockets 16.

The use of the central hole 22 facilitates centralisation of the prosthesis when anchored to the implant, and the aforementioned problem of proper prosthesis location and alignment, which is encountered when the implant is anchored in a non-centralised root socket 16, can be avoided. Whereas previously known molar implants had a relatively small angle of taper, typically not more than about 7.8°, the proposed use of a greater diameter implant in the present invention is permitted by simultaneously using a greater taper angle 46. The greater taper angle keeps the overall length of the implant, and in particular the threaded length which is anchored in the socket, within the limits imposed by the natural geometry of the jawbone and avoids the necessity to remove excessive bone during drilling or reaming of the hole 22.

In order to screw the implant into the jawbone, the hexagonal boss 30 or the three holes 32 can be engaged by a suitable spanner or other tool which is used to rotate the implant. The prosthesis (not shown) is then anchored to the implant in the normal way by means of a screw (not shown) screwed into an internally threaded bore 60. In FIG. 3, the bore 60 proceeds inwardly or apically from the boss and is aligned on the central axis of the implant.

Although mention has been made of a molar tooth having three roots, it will be understood that the principles of the invention are equally applicable to implants for teeth with different root configurations and/or numbers of roots.

FIGS. 5, 6 and 7 respectively show second, third and fourth embodiments 70, 72, and 74 respectively of molar implants according to the invention. These embodiments operate in the same manner as the molar implant 24 described above. However, the molar implant 70 differs from the implant 24 in that its cylindrical threaded portion 38.2 does not stand proud of the circumferential surface 29 of the end 26. In fact, the circumferential surface 29 of the end 26 extends radially beyond the threaded portion 38.2.

In yet another embodiment (not illustrated) it would be possible for the diameter of the circumferential surface 29 to match the major diameter of the thread in the portion 38.2.

The molar implant 72 seen in FIG. 6 differs from the implant 24 in that there is no projecting boss at the end 26. Instead, there is a non-circular socket 76 which leads axially to the threaded bore 60 and which can be engaged by a suitable tool for the purposes of rotating the implant in order to screw it into the hole 22. The illustrated socket 76 is parallel sided and of hexagonal cross-section but it will be understood that other tool-engagable socket shapes are within the scope of the invention.

Persons skilled in the art will be well aware of the fact that at times the axis of a crown of a tooth is substantially angled relative to the axis of its roots. In order to deal with such situations, molar implants such as the implant 74 of FIG. 7 can be used. Here the end 26 is shaped as shown in order for the axis 80 of the bore 60 to be angled relative to the axis 78 of the tapered shank 34 by the angle 82.

It will be understood that an arrangement in which the axis of the coronal end is inclined relative to the axis of the shank can be provided in any of the other embodiments described above.

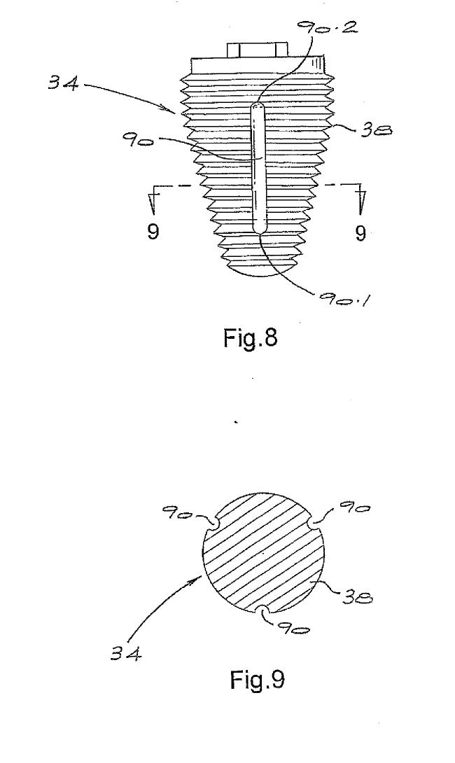

FIGS. 8 and 9 illustrate a further modification. The implant seen in these Figures differs from that illustrated in FIGS. 3 and 4 in that the thread 38 is intersected, substantially at right angles, by longitudinally extending grooves 90. An advantage of this feature is that the surrounding bone can, after installation of the implant, grow into the longitudinal grooves and thereby improve the integrity of the anchorage.

It will be noted that the grooves do not extend longitudinally for the full extent of the thread 38. The inner or apical ends 90.1 of the grooves terminate short of the end of the thread 38 at the inner or apical end 36 of the implant. This is considered advantageous in that, if the grooves did continue right to the inner end of the thread their ends could be open at the bottom of the hole 22 and could, for instance, allow undesirable ingress of bacteria from a sinus cavity which may have been penetrated by the hole 22 during formation thereof. The outer or coronal ends 90.2 of the grooves 90 also terminate short of the end of the thread 38 towards the outer or coronal end of the implant, i.e. towards the end 26, in this case to prevent possible ingress of bacteria from the oral cavity.

In FIG. 9 it will be noted that there are three grooves 90 spaced apart from one another by 120°, but it will be understood that other embodiments may have one, two or more than three such grooves. It will also be understood that grooves such as the grooves 90 may be provided in any of the other embodiments described above.

1. A molar implant comprising a body having a coronal end into which a threaded bore extends to receive a fastener for a prosthesis and an externally threaded shank extending from the coronal end, at least a portion of the shank being inwardly tapered, the thread of the shank defining a major diameter of at least 8 mm and the shank having a taper angle in the range 10° to 25°.

2. A molar implant according to claim 1 wherein the taper angle of the shank is in the range 11.6° to 19.9°.

3. A molar implant according to claim 1 wherein the shank has a round cylindrical, threaded portion adjacent the coronal end and a conically tapered, threaded portion extending apically from the round cylindrical portion.

4. A molar implant according to claim 3 wherein the thread of the round cylindrical portion of the shank defines a greater major diameter than the coronal end of the implant.

5. A molar implant according to claim 3 wherein the diameter of the coronal end of the implant is greater than a major diameter defined by the thread of the round cylindrical portion of the shank.

6. A molar implant according to claim 3 wherein the diameter of the coronal end of the implant is the same as a major diameter defined by the thread of the round cylindrical portion of the shank.

7. A molar implant according to claim 1 wherein the coronal end, the threaded bore and the shank are coaxially aligned with one another.

8. A molar implant according to claim 1 wherein the coronal end and the threaded bore have a common, first axis and the shank has a second axis which is inclined relative to the first axis.

9. A molar implant according to claim 1 wherein the coronal end carries a projecting, tool-engagable boss.

10. A molar implant according to claim 9 wherein a coronal surface at the coronal end has a plurality of blind holes therein.

11. A molar implant according to claim 1 wherein the coronal end has a tool-engagable socket therein leading to the threaded bore.

12. A molar implant according to claim 1, further including at least one external, longitudinally extending groove intersecting the thread of the shank.

13. A molar implant according to claim 12 wherein each groove has an apical end which terminates short of an apical end of the thread.

14. A molar implant according to claim 12 wherein each groove has a coronal end which terminates short of a coronal end of the thread.

15. A molar implant according to claim 12 including three grooves spaced apart from one another by 120°.

16. A surgical method including the steps of extracting a molar tooth from a maxilla or mandible, forming a hole in the bone of the maxilla or mandible at a generally central position relative to the sockets left by the extracted molar tooth, and screwing an implant into the formed hole, the implant comprising a body having a coronal end into which a threaded bore extends to receive a fastener for a prosthesis and an externally threaded shank extending apically from the coronal end, at least a portion of the shank being inwardly tapered, the thread of the shank defining a major diameter of at least 8 mm and the shank having a taper angle in the range 10° to 25°.

17. A surgical method according to claim 16 wherein the hole which is formed in the bone has a diameter greater than the lateral dimensions of sockets left in the bone by the extracted molar tooth.

18. A surgical method according to claim 16 wherein the taper angle of the shank of the implant is in the range 11.6° to 19.9°.
